(19) United States
(12) Patent Application Publication
(10) Pub. No.: US 2024/0097153 A1
(43) Pub. Date: Mar. 21, 2024

(54) REINFORCED SEALING STRUCTURE FOR FUEL CELL APPLICATIONS

(71) Applicant: Aerostack GmbH, Dettingen an der Erms (DE)

(72) Inventors: Robert ALINK, Dettingen an der Erms (DE); Karsten DAHL, Dettingen an der Erms (DE)

(21) Appl. No.: 18/238,839

(22) Filed: Aug. 28, 2023

(30) Foreign Application Priority Data
Sep. 16, 2022 (DE) 102022123800.8

(51) Int. Cl. H01M 8/028; H01M 8/0286

(52) U.S. Cl. CPC H01M 8/028; H01M 8/0286

(57) ABSTRACT

A cell seal for a fuel cell having a support portion and a seal portion. The seal portion includes a sealing material to prevent passage of a fluid. The support portion includes a porous material, for example a fabric, and is configured to impart a mechanical stability to the cell seal. The sealing material of the seal portion penetrates the porous material at least partially and thus connects the seal portion to the support portion. In one version, the support portion is also used to connect different sealing regions mechanically to one another. A fuel cell having such a cell seal, wherein the cell seal is between two bipolar plates, and a method for producing the cell seal, are disclosed.

### TECHNICAL FIELD

The present disclosure relates to sealing concepts in general and in particular to sealing concepts for fuel cell applications.

### BACKGROUND

In fuel cells, or fuel cell stacks, seals are used for sealing the individual media spaces of the cell itself from one another (fuel side from oxidant side), and the distributor lines, and for sealing individual fuel cells in a fuel cell stack from one another. The function of the seal is in this case, in particular, to prevent internal leaks (for example from the anode side to the cathode side and vice versa) and external leaks (for example between individual fuel cells in a stack). In general, cell seals are made from a relatively soft polymer which is very flexible. This makes handling during installation more difficult, particularly in the case of automated installation in manufacturing plants. This problem is further exacerbated in particular by the significantly larger lateral dimensioning of the seal in comparison with the seal height (for example several decimeters in comparison with less than one millimeter), since irregularities in the seal may be formed because of the flexibility and production-related causes. The irregularities create problems above all in the positioning of the component parts relative to one another, as well as due to errors in the positioning of the seal on the component parts.

In the prior art, seals having a plastic frame at the edge are known, in order to receive the seal in a planar fashion and allow positioning of the seal relative to the bipolar plate on the outer contours. Such plastic frames, however, may only be produced complexly by multicomponent injection molding. Furthermore, the attachment of the seal material to the plastic frame proves to be difficult and prone to error.

### SUMMARY

Accordingly, it is an object of the disclosure herein to provide a cell seal for fuel cells, which is planar and stable and which can be produced and mounted in an automated fashion.

This object is achieved by a cell seal disclosed herein. Further embodiments may be found in the following description.

According to a first aspect, a cell seal for a fuel cell is provided. The fuel cell comprises a support portion and a seal portion. The seal portion comprises a sealing material. The sealing material is configured to prevent passage of a fluid. The support portion comprises a porous material and is configured to impart a mechanical stability to the cell seal and to improve the producibility of the seal. The sealing material of the seal portion penetrates the porous material at least partially and thus connects the seal portion to the support portion.

The cell seal is configured flatly, with or without a structured profile, and may in principle be used at any suitable position in the fuel cell. For example, the cell seal may be applied between the anode side and the cathode side in order to avoid leaks between these regions. At the same time, the cell seal may also seal the distributor lines inside the fuel cell or in a fuel cell stack, which are used to distribute the fuel and the oxidant onto the respective anode and cathode sides. In general, seals provide sealing of fluid flows by a resilient sealing material, for example an elastomer. Such materials have a relatively high flexibility. Particularly in the case of seals with large lateral dimensioning, such as are used in fuel cells, this flexibility may make arrangement and positioning of the cell seal inside the fuel cell or inside the fuel cell stack more difficult. This is disadvantageous particularly in the case of automated mounting. In the present case, flexibility is intended to mean that, because of its properties, a flexible material is deformed significantly by its own weight or internal stresses if it is not held or supported by a further component part.

The support portions used therefore serve for mechanical stiffening of the cell seal, or its shape, and are intended to impair the resilience for the seal effect itself as little as possible.

The support portion offers a high mechanical flexural stiffness/low flexibility and may be present at any suitable position in the region of the cell seal. The support portion is in this case firmly connected to the seal portion and thereby supports the cell seal. The support portion may in this case be a continuous region and, for example, be arranged around an edge of the plane of the cell seal. The support portion may, however, also be present only locally in regions of the cell seal at which mechanical stiffening is desirable, so that more than one support portion may also be present, in which case these plurality of support portions may be spaced apart from one another or else adjacent to one another. In such an embodiment, individual local support portions may for example be connected to one another by a seal portion, in which case a plurality of seal portions may also be applied on a support portion and penetrate the latter. The support portion may, however, also occupy the entire area of the cell seal and seal portions may be connected to the support portion, or penetrate the latter, at corresponding regions, as described below, that is to say the cell seal may also comprise more than one seal portion, these respectively being connected to at least one support portion. The individual large-area support portion then serves as a (porous) base layer of the cell seal. In this way, it is possible to achieve maximal mechanical supporting and a material saving of seal material, as well as a weight reduction.

Particularly in order not to impair the mechanical properties of the seal in the sealing region by the support structure, the seal portions may be arranged next to the support portion and connect a plurality of support portions, or terminate them laterally. The seal portions may, however, also be applied on the support portion or penetrate the latter, a plurality of seal portions may therefore be arranged on one support portion.

The seal portion is used to seal against fluid leaks and may be a continuous region, for example a seal lip, which extends in the plane of the seal along the regions to be sealed. The seal portion may, however, also merely be a locally limited region in which a corresponding seal lip/seal is present.

The seal portion is connected to the support portion in such a way that the sealing material of the seal portion penetrates locally into the support portion and produces a mechanical connection/interlock. The support portion is for this purpose made from a porous material. The porous material in this case comprises, in particular, a solid matrix having interstices which can be filled by a fluid or gas. The solid matrix may, for example, be a fiber-based substance such as a fabric. The fabric in this case comprises a network or a matrix of individual fibers (or fiber bundles) of a fabric material. The sealing material of the seal portions is then injected through or onto the porous material during the manufacture of the cell seal, as described below, so that the sealing material extends into or through the interstices in the porous material while filling the interstices at least partially and enclosing the solid matrix of the porous material. A firm connection (which may be referred to as a form-fit or materially-bonded connection) of the sealing material (and therefore of the seal portion) to the porous material is therefore achieved.

By the penetrating connection, a large contact area between the support portions and the seal portions, and therefore very good bonding of the seal portions to the support portions, are achieved overall. In addition, the porous material may be brought into the corresponding shape beforehand, for example by stamping or cutting, so that an elaborate multicomponent injection molding method for connecting the seal portion and the support portion is no longer necessary. Unlike for example in the case of a plastic frame/polymer frame as a support element, mechanical undercuts/bores in the frame/support portion, in which the sealing material can interlock or engage, are furthermore not necessary. Furthermore, the likelihood of material distortion due to a stamping or cutting process is minimized, so that automated delivery in the further processing operation is simplified.

According to one embodiment, the sealing material comprises an elastomer.

Because of their material properties, such elastomers provide a good seal effect. The aforementioned problems of the flexibility may be overcome by bonding to the porous material of the support portion.

According to a further embodiment, the cell seal is flatly configured.

The support portion and the seal portion therefore form a substantially common plane, or extend in a common plane. The support portion in this case provides the cell seal as a whole with a sufficient mechanical stiffness so that the cell seal may be inserted easily into a fuel cell, in particular including by a machine, during assembly. This structure ensures that an inherently flexible seal material can nevertheless be kept in a flat or planar shape (or another desired shape predetermined by the support portion) and can be positioned with the further cell components.

According to a further embodiment, the support portion is arranged circumferentially on an edge of the cell seal.

By such an arrangement, the entire area inside the support portion may be used for the seal portion, which provides maximal design freedom for the seal portion.

According to a further embodiment, the support portion occupies at least 80% of the area of the cell seal in a plan view. The sealing material of the seal portion is injected into the porous material of the support portion at a position to be sealed and permeates a corresponding portion of the porous material.

Since the sealing material of the seal portion is connected to the support portion in a penetrating fashion, as described above, the support portion may also be present over a large part of the area of the cell (including sealing regions and distributor contours), or of the cell seal. Preferably, the support portion occupies at least 60% of the area of the cell seal (or of the cell when installed). More preferably, the support portion occupies at least 70% of the area. Even more preferably, the support portion occupies at least 80% of the area. Most preferably, the support portion occupies at least 90% of the area. In particular, the support portion may also occupy the entire area of the cell seal. In this case, it is to be noted that the entire area of the cell, or of the cell seal, means of course only the regions on which some component of the cell seal is actually present. In particular, it therefore does not mean that a homogeneously continuous area of the cell seal is covered with the support portion. For example, no support portion is present at the passages of the distributor channels of the fuel cell or in the electrocatalytically active region of the cell area, in order to ensure normal functionality of the fuel cell.

Maximal stiffening/reinforcement may be achieved by the large-area application of the support portion. The seal portion or the seal portions may then be connected to the support portion in the regions to be sealed.

According to one embodiment, the porous material comprises a fabric.

According to a further embodiment, the fabric is a glass fiber fabric.

According to a second aspect, a fuel cell is provided. The fuel cell comprises a first bipolar plate, a second bipolar plate, a membrane and a cell seal according to one of the embodiments described above. The membrane is arranged between the first bipolar plate and the second bipolar plate. The cell seal is arranged between the first bipolar plate and the second bipolar plate.

The cell seal may be configured according to any of the embodiments described herein, and is used to seal against leaks between the anode side and the cathode side of the fuel cell as well as the distributor supply lines.

According to a third aspect, a method for producing a cell seal as described above is provided. The method comprises stamping or cutting the porous material so that the porous material forms the support portion, placing the porous material in a molding tool, which has a negative shape of the sealing portion, holding the porous material in the molding tool, introducing the sealing material into the molding tool, and curing the cell seal in the molding tool.

As indicated further above, the cell seal of the present disclosure may be produced in a simple and economical way. For this purpose, a corresponding shape of the support portions is stamped from a porous material. This stamped porous material may then be placed manually or in an automated fashion as an inlay in a corresponding molding tool and, in particular, does not need to be manufactured by a complicated multicomponent injection molding method as a premolded article. The molding tool has a negative shape of the cell seal to be produced. In particular, the molding tool has corresponding cavities of the seal portions described with reference to the cell seal. The stamped porous material may be held in the molding tool by any suitable method. The porous material may in this case, for example, be clamped in the molding tool at corresponding points, or held in the mold by a vacuum. This list is however only exemplary in nature, and other methods may likewise be envisioned. The introduction of the sealing material may, for example, be carried out by injection/injection molding. By the injection of the sealing material into the molding tool, it can fill the porous material, or the cavities of the support portion, at least partially while enclosing the solid matrix. After the curing, a firm connection is thus created between the porous material of the support portion or portions and the sealing material of the seal portion or portions. The sealing material may in particular be an elastomer material, or alternatively any other material which provides sealing of a fluid flow. The porous material of the support portion may be any suitable porous material which provides a sufficient stiffness for mechanical stiffening of the cell seal.

The porous material used for the support portion should in this case itself have a certain compressibility in order to allow sealing of the molding tool during the injection process and, for example, to allow a low-viscosity elastomer to be restricted to the desired regions in the molding tool.

According to one embodiment, the holding of the stamped porous material in the molding tool is carried out by generating a vacuum in the molding tool.

The molding tool may for this purpose have a vacuum connector so that a vacuum, which holds the porous material on the molding tool, can be generated in or behind the stamped porous material placed in it.

According to a further embodiment, the placing of the stamped porous material in the molding tool comprises placing the porous material in a molding tool having at least one local support structure, which holds the porous material at a distance from inner walls of the molding tool. The holding of the porous material is achieved by the local support structure so that sealing portions are formed on both sides of the porous material during the subsequent injection of the sealing material.

In this embodiment, for example, the porous material is held in the molding tool at a distance from the inner walls of the molding tool by corresponding local support structures in the mold halves of the molding tool. In this way, the sealing material can penetrate through the porous material during the injection so that it emerges again from the porous material from the other side and thus forms seal portions on both sides of the plane of the support portion. This also allows, in particular, the use of a support portion which occupies a large part of the area of the cell seal around the active cell face and therefore contributes to maximal stiffening of the seal contour and minimization of the amount of seal material used. The use of a porous material as one or more support portions in this case facilitates in particular such bilateral application of the sealing material since the material only needs to be injected from one side of the molding tool. Complicatedly constructed molding tools are therefore not necessary. By this embodiment, furthermore, the accuracy of the arrangement of the seal structures relative to one another and relative to the further component part contours is increased in that movement of the seal contours is significantly restricted by the bonding of the seal structures to a fixed contour. Causes of this movement may for example be the inherent flexibility of the seal materials, absorption effects, thermal expansion, ageing effects or curing effects.

In summary, the disclosure herein thus provides a cell seal for fuel cells, which may be installed easily, in particular by a machine, during assembly of the fuel cell, in that the flexibility is reduced. By the use of porous materials as a support structure, the production of bilateral seal structures in one process step is possible, the support structures being producible easily and ensuring very good mechanical bonding to the seal structure. Complicated multicomponent injection molding methods are furthermore no longer necessary for producing the seal, since the support portions may be placed manually or in an automated fashion as prefabricated inlays during the injection of the cell seal, or of the seal portions of the cell seal, and do not need to be pre-injected. In the case of plastic frames as mechanical supports for seals, this can be done only with difficulty inter alia because of the different thermal expansions of the materials, which lead to a distortion. In addition, good bonding of the seal portions to the support portions is achieved by the use of the porous material, without the difficulties of bonding an elastomer material to a plastic material. This is achieved in particular by the porosity of the material. The disclosed seal concept also allows a very high degree of design freedom and a reduction of the costs of the production method both of the cell seal and of the fuel cell itself. The frame of porous material may simply be placed in the molding tool by a machine and imparts mechanical reinforcement to the cell seal, so that the cell seal can also be installed in the fuel cell easily during assembly. In this way, in particular, mass production is significantly facilitated. By the use of a large-area support structure, expensive seal material is in addition saved and the costs and weight of the seal component part are thereby reduced. Furthermore, the positioning accuracy of the seal contours is increased by the application to a solid material with a support effect.

### BRIEF DESCRIPTION OF THE DRAWINGS

Example embodiments will be discussed in more detail below with the aid of the appended drawings. The representations are schematic and not true to scale. References which are the same refer to elements which are the same or similar.

FIG. 1 shows a schematic plan view of one configuration of a cell seal for a fuel cell.

FIG. 2 shows a cross-sectional view of the cell seal of FIG. 1.

FIG. 3 shows a schematic plan view of another configuration of a cell seal for a fuel cell.

FIG. 4 shows a cross-sectional view of the cell seal of FIG. 3.

FIG. 5 shows a schematic sectional representation as an exploded view of a fuel cell with two cell seals according to FIGS. 1 to 4.

FIG. 6 shows a flowchart of a method for producing a cell seal.

### DETAILED DESCRIPTION

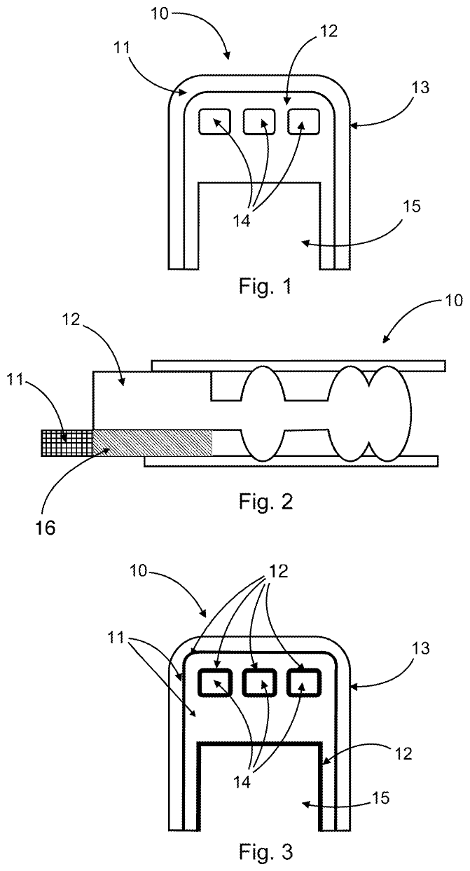

FIG. 1 shows an example configuration of a cell seal 10 in a plan view. FIG. 2 shows a sectional representation of the cell seal 10 of FIG. 1. FIGS. 1 and 2 will therefore be described together below. The cell seal has three passage openings/distributor openings 14, which are used for example for cooling liquid and the reaction gases to pass through the fuel cell, or between individual fuel cells in a fuel cell stack, and a membrane opening 15 which, depending on the fuel cell used, in a known manner allows passage of positive or negative ions through a membrane of the fuel cell. The cell seal has a support portion 11, which extends on an outer edge 13 of the cell seal 10 and forms the outer edge of the cell seal 10, and a continuous seal portion 12 which is connected to the support portion 11.

The support portion 11 comprises a porous material, for example a glass fiber fabric, which consists of individual fibers or fiber bundles interwoven with one another. Formed between the fibers, there are interstices in which no fabric material is present. The seal portion 12 in turn comprises a sealing material, optionally structured with seal structures (for example seal lips), for example a corresponding elastomer, which fills at least partially the interstices in the fabric at least in the transition region (this is most clearly visible in FIG. 2) and thus mechanically connects the seal portion 12 to the support portion 11. Because of the relatively large contact area of the sealing material with the individual fibers of the fabric, good bonding of the seal portion 12 and the support portion 11 is achieved.

In the configuration represented in FIGS. 1 and 2, the support portion 11 is present only on the edge 13 of the cell seal 10. The seal portion 12 (which is continuous here) is in turn supported by the support portion 11 in order to impart a mechanical strength to the cell seal 10 (that is to say to reduce the flexibility of the cell seal, in particular of the seal portion 12). Elements may for example also be introduced into the support portion 11 in order to be able to position the cell seal in relation to the further cell components. This facilitates automated machine mounting of the cell seal 10 in the fuel cell. Although the seal portion 12 is represented as a continuous homogeneous region in FIG. 1, it is to be noted that the seal portion 12 may also have corresponding contours/structures in order to improve the seal effect. This is indicated in FIG. 2 by the individual regions (for example seal lips) which are in contact with adjacent plates. It may furthermore be seen in FIG. 2 that the support portion is present only on one surface of the cell seal 10. For example, such a configuration allows the support portion 11 to be held by a vacuum during manufacture in a molding tool. In another version, the support portion may however also be applied centrally or on the opposite side. FIG. 2 also schematically represents a region 16 of the support portion which is permeated by the sealing material. In this region, the sealing material penetrates the support portion at least partially and thus provides a connection of the seal portion 12 to the support portion 11. The permeated region 16 therefore corresponds to a region of the support portion 11 into which the sealing material is introduced/injected.

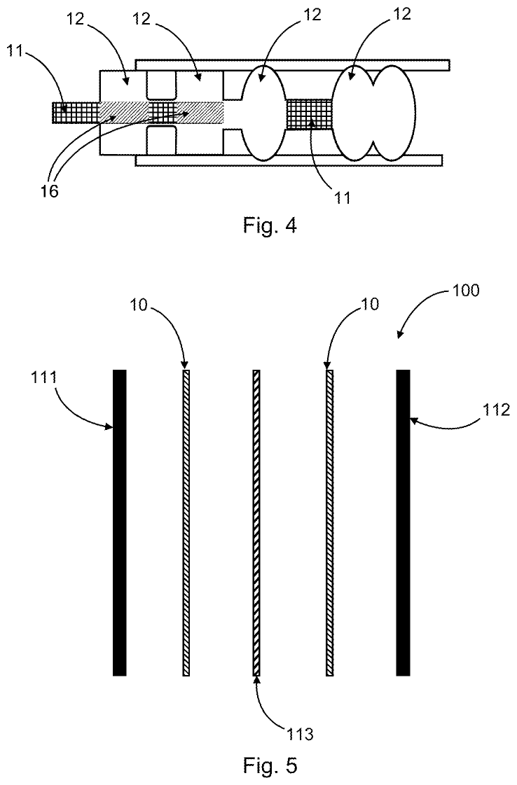

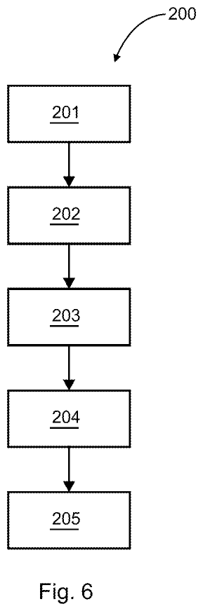

FIGS. 3 and 4 schematically show an alternative configuration of the cell seal 10. FIG. 3 shows the cell seal 10 again in a plan view, while FIG. 4 is a sectional representation of the cell seal 10 of FIG. 3. FIGS. 3 and 4 will be described together below. The cell seal 10 comprises a support portion 11 and a plurality of seal portions 12, and again distributor openings/coolant openings 14 and a membrane opening 15. In contrast to the configuration of FIGS. 1 and 2, the support portion 11 in FIGS. 3 and 4 is present over a larger area in all regions of the cell seal 10 (naturally with the exception of the distributor openings 14 and the membrane opening 15) and serves as a mechanical connection between the otherwise independent seal regions 14. The plurality of seal portions in the configuration represented are corresponding seal lips around the openings 14 and 15 in order to seal these regions in a known manner. One of the seal portions 12 also encloses the entire cell area. The seal portions 12 may again have corresponding structures (which may be seen in FIG. 4). In the configuration of FIGS. 3 and 4, the support portion is not present on only one surface of the cell seal 10 but is arranged centrally in the cell seal 10 between the two surfaces thereof. Since the porous material of the support portion 11 is porous, the sealing material of the seal portions 12 may be injected easily through the porous material during the production of the cell seal 10, and thus forms the seal portions 12 on both sides of the cell seal 10, as described further below with reference to FIG. 6. In FIG. 4, similarly as in FIG. 2, permeated regions 16 of the support portion 11, in which the sealing material penetrates the support portion 11, are also represented by hatching. In these regions, the seal portion 12 is therefore bound to the support portion in a penetrating fashion. It may likewise be seen in FIGS. 3 and 4 that the seal material may not only be injected through the porous material but may also be introduced into recesses of the support material, or also serves to connect different regions of the support material to one another. This may be seen particularly in FIG. 4 by the central seal portion 12, which lies between two support portions 11.

The configuration of FIGS. 3 and 4 allows particularly good mechanical stiffening of the cell seal 10 since the support portions are present in a large area over the entire cell seal 10. In addition, by the restriction of the seal portions 12 to the regions to be sealed (for example openings 14, 15), a particularly lightweight seal with great material saving, particularly of the seal material, is provided.

The cell seals 10 both of FIGS. 1 and 2, and of FIGS. 3 and 4, provide (for example compared with pure seals without reinforcement but also compared with seals having plastic frames) very planar/flat seals which can be positioned well. The handling during installation, particularly in machine and automated manufacture, is therefore facilitated and the manufacturing costs are reduced owing to the simpler tools required.

FIG. 5 shows a schematic representation of a fuel cell 100 having two cell seals according to FIGS. 1 to 4 in an exploded view. A membrane 113 is applied between two bipolar plates 111, 112, which in an individual fuel cell 100 correspond to the anode and the cathode. A first cell seal 10 is applied between the first bipolar plate 111 and the membrane 113. A second cell seal 10 is applied between the second bipolar plate 112 and the membrane. The cell seals 10 are used to seal the anode side and the cathode side against leaks, both from one another and from the cell exterior.

FIG. 6 represents a flowchart of a method 200 for producing a cell seal (for example the cell seal 10 of FIGS. 1 to 4) according to the present disclosure.

The method begins in step 201 with the stamping or cutting of a porous material so that the porous material forms a support portion 11. The porous material may in this case be any desired suitable porous material which provides mechanical stiffening. For example, the porous material may be a glass fiber fabric. This is only an example, however, and other materials are likewise possible. The porous material is a blank which is correspondingly stamped or cut in order to have the required contour/shape (for example the shapes which are represented in FIGS. 1 to 4). In this case, however, it is to be noted that the porous material should have a certain compressibility in order to seal the molding tool sufficiently in the subsequent steps, so that the sealing material, which is conventionally for example a low-viscosity elastomer, is restricted to the contour to be injected.

After step 201, the stamped porous material is placed in a molding tool in step 202. The molding tool has a negative shape of the cell seal 10 to be produced, that is to say in particular cavities with the shape of the seal portion 12, so that the seal portions 12 are formed during the injection of the sealing material.

In step 203, the porous material is held in the molding tool. This may, for example, be done by using a vacuum. It is, however, also possible for local support structures to hold and clamp the porous material at a distance from the inner walls of the molding tool. For example, it is thus possible to form a cell seal 10 according to FIGS. 3 and 4, in which the support portion 11 extends in the middle of the cell seal 10 and the seal portions 12 are formed on both sides of the cell seal 10.

In step 204, the sealing material is introduced into the molding tool, for example by injection, and in step 205 it is cured in order to form the finished cell seal 10. During the injection, the sealing material penetrates the porous material of the support portion as described further above herein. During the curing, a good bond is thus created between the seal portion/portions 12 and the support portion/portions 11. If the porous material is placed in step 202 in a molding tool having local support structures which hold the porous material at a distance from the inner walls of the molding tool, during the injection in step 204 the sealing material may penetrate the porous material from the injection side and emerge again on the other side so as to form seal portions 12 on both sides of the cell seal.

It should additionally be pointed out that “comprising” or “having” does not exclude other elements or steps, and “a” or “an” does not exclude a multiplicity. It should furthermore be pointed out that features or steps which have been described in respect of one of the example embodiments above may also be used in combination with other features or steps of other example embodiments described above. References in the claims are not to be regarded as a restriction.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCES

10 cell seal
11 support portion
12 seal portion
13 edge
14 distributor openings/coolant openings
15 membrane opening
16 region of the support portion permeated by sealing material
100 fuel cell
111 first bipolar plate
112 second bipolar plate
130 membrane
200 method
201 stamping or cutting
202 placing
203 holding
204 injecting
205 curing

1. A cell seal for a fuel cell, comprising:
a support portion; and
a seal portion;
wherein the seal portion comprises a sealing material;
wherein the sealing material is configured to prevent passage of a fluid;
wherein the support portion comprises a porous material and is configured to impart a mechanical stability to the cell seal; and
wherein the sealing material of the seal portion penetrates the porous material at least partially and connects the seal portion to the support portion.

2. The cell seal of claim 1, wherein the sealing material comprises an elastomer.

3. The cell seal of claim 1, wherein the cell seal is flatly configured.

4. The cell seal of claim 1, wherein the support portion is arranged circumferentially on an edge of the cell seal.

5. The cell seal of claim 3, wherein the support portion occupies at least 80% of an area of the cell seal in a plan view; and
wherein the sealing material of the seal portion is injected into the porous material of the support portion at a position to be sealed and permeates a corresponding portion of the porous material.

6. The cell seal of claim 1, wherein the porous material comprises a fabric.

7. The cell seal of claim 6, wherein the fabric is a glass fiber fabric.

8. A fuel cell, comprising:
a first bipolar plate and a second bipolar plate;
a membrane; and
a cell seal of claim 1;
wherein the membrane is between the first bipolar plate and the second bipolar plate;
wherein the cell seal is between the first bipolar plate and the second bipolar plate.

9. A method for producing a cell seal of claim 1, comprising:
stamping or cutting a porous material so that the porous material forms the support portion;
placing the stamped porous material in a molding tool, which has a negative shape of the sealing portion;
holding the porous material in the molding tool;
introducing the sealing material into the molding tool; and
curing the cell seal in the molding tool.

10. The method of claim 9, wherein the holding of the stamped porous material in the molding tool is carried out by generating a vacuum in the molding tool.

11. The method of claim 9, wherein the placing of the stamped porous material in the molding tool comprises placing the porous material in a molding tool having at least one local support structure, which holds the porous material at a distance from inner walls of the molding tool, and the holding of the porous material is achieved by the local support structure so that sealing portions are formed on both sides of the porous material during the subsequent injection of the sealing material.
